(19) United States
(12) Patent Application Publication
(10) Pub. No.: US 2020/0062012 A1
(43) Pub. Date: Feb. 27, 2020

(54) PRINTING DEVICE, PRINTING SYSTEM, PRINTING METHOD, AND RECORDING MEDIUM

(71) Applicant: CASIO COMPUTER CO., LTD., Tokyo (JP)

(72) Inventor: Sumito SHINOHARA, Tokyo (JP)

(21) Appl. No.: 16/544,544

(22) Filed: Aug. 19, 2019

(30) Foreign Application Priority Data
Aug. 23, 2018 (JP) 2018-156282

(51) Int. Cl. B41J 21/16; B41J 3/44; B41J 3/28

(52) U.S. Cl. CPC B41J 21/16; B41J 3/28; B41J 3/44

(57) ABSTRACT

A printing device includes a housing, a print head, a scanner, and a processor. The print head includes print elements arranged linearly in a set direction in the housing. The scanner is disposed ahead of the print head in a scan direction that intersects the set direction and is a direction in which the housing is moved and acquires an image of a print medium. When determining that the image acquired by the scanner includes a reference pattern that serves as a reference of an intended position at which a print subject is to be printed, The processor controls the print head to print the print subject at the intended position that is a set distance away from a position of the reference pattern in the scan direction and is adjusted in the set direction based on the position of the reference pattern.

### CROSS-REFERENCE TO RELATED APPLICATION

This application claims the benefit of Japanese Patent Application No. 2018-156282, filed on Aug. 23, 2018, the entire disclosure of which is incorporated by reference herein.

### FIELD

The present disclosure relates to a printing device, a printing system, a printing method, and a recording medium.

### BACKGROUND

A manual scanning type printing device is known that prints a print subject, such as characters, symbols, logos, and marks, on a print medium by a user moving the printing device with its housing grasped. This type of printing device is provided with a print head at a bottom surface of the housing, and thus has difficulties in recognition of where the print subject is to be printed.

For easy recognition of the printing position, a manual scanning type printing device described in US Patent Application Publication No. 2007/0223982 includes a standard indicator arranged in the vicinity of the bottom surface of the housing, and a display that displays a relative positional relationship between the standard indicator and an image to be printed.

### SUMMARY

According to an aspect of the present disclosure, a printing device includes a housing, a print head, a scanner, and a processor. The print head includes print elements arranged linearly in a set direction in the housing. The scanner is disposed ahead of the print head in a scan direction that intersects the set direction and is a direction in which the housing is moved, and acquires an image of a print medium. The processor is configured to control, when determining that the image acquired by the scanner includes a reference pattern that serves as a reference of an intended position at which a print subject is to be printed, the print head to print the print subject at the intended position that is a set distance away from a position of the reference pattern in the scan direction and is adjusted in the set direction based on the position of the reference pattern.

A printing method according to another aspect of the present disclosure is performed for a printing device that includes a housing, a print head including print elements arranged linearly in a set direction in the housing, and a scanner disposed ahead of the print head in a scan direction that intersects the set direction and is a direction in which the housing is moved and configured to acquire an image of a print medium. The printing method includes controlling, when determining that the image acquired by the scanner includes a reference pattern that serves as a reference of an intended position at which a print subject is to be printed, the print head to print the print subject at the intended position that is a set distance away from a position of the reference pattern in the scan direction and is adjusted in the set direction based on the position of the reference pattern.

According to yet another aspect of the present disclosure, a non-transitory computer-readable recording medium stores a program for execution on a computer for controlling a printing device that including a housing, a printing head including print elements arranged linearly in a set direction in the housing, and a scanner disposed ahead of the print head in a scan direction that intersects the set direction and is a direction in which the housing is moved and configured to acquire an image of a print medium. The program causes the computer to execute controlling, when determining that the image acquired by the scanner includes a reference pattern that serves as a reference of an intended position at which a print subject is to be printed, the print head to print the print subject at the intended position that is a set distance away from a position of the reference pattern in the scan direction and is adjusted in the set direction based on the position of the reference pattern.

### BRIEF DESCRIPTION OF THE DRAWINGS

A more complete understanding of this application can be obtained when the following detailed description is considered in conjunction with the following drawings, in which:

FIG. 1 is a drawing illustrating a handy printer and a terminal device according to an embodiment of the present disclosure;

FIG. 2 is a top view illustrating the handy printer according to the embodiment of the present disclosure;

FIG. 3 is a bottom view illustrating the handy printer according to the embodiment of the present disclosure;

FIG. 4 is a block diagram illustrating a configuration of the handy printer according to the embodiment of the present disclosure;

FIG. 5 is a block diagram illustrating a configuration of the terminal device according to the embodiment of the present disclosure;

FIG. 6 is a flow chart illustrating a print subject transmission process executed by the terminal device according to the embodiment of the present disclosure;

FIG. 7 is a flow chart illustrating a printing process executed by the handy printer according to the embodiment of the present disclosure;

FIG. 8 is a flow chart illustrating a dot-line printing process executed by the handy printer according to the embodiment of the present disclosure;

FIG. 9 is a drawing for description of the printing process executed by the handy printer according to the embodiment of the present disclosure;

FIG. 10 is a drawing for description of the printing process executed by the handy printer according to the embodiment of the present disclosure;

FIG. 11 is a drawing for description of the printing process executed by the handy printer according to the embodiment of the present disclosure;

FIG. 12 is a drawing for description of the printing process executed by the handy printer according to the embodiment of the present disclosure;

FIG. 13 is a drawing for description of the printing process executed by the handy printer according to the embodiment of the present disclosure;

FIG. 14 is a drawing for description of the printing process executed by the handy printer according to the embodiment of the present disclosure;

FIG. 15 is a drawing for description of the printing process executed by the handy printer according to a modified embodiment of the present disclosure;

FIG. 16 is a drawing for description of the printing process executed by the handy printer according to the modified embodiment of the present disclosure;

FIG. 17 is a drawing illustrating a handy printer according to another modified embodiment of the present disclosure; and

FIG. 18 is a drawing illustrating a table stored in a handy printer according to yet another modified embodiment of the present disclosure.

### DETAILED DESCRIPTION

A printing device according to an embodiment of the present disclosure is described below with reference to the drawings.

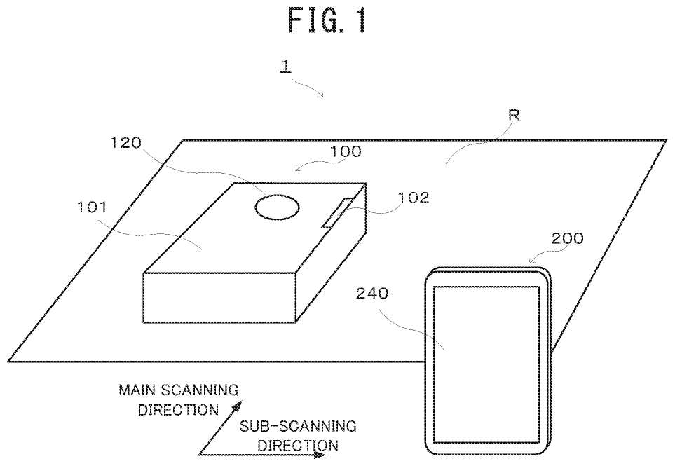

A handy printer (printing device) 100 according to an embodiment of the present disclosure includes a housing 101 sized to be easily grasped by a user by hand, as illustrated in FIG. 1. The handy printer 100 has a function of printing, while being moved by a user in a sub-scanning direction, a print subject, such as characters, symbols, logos, icons, and marks, on a print medium R using a reference pattern preprinted on the print medium R as a reference of the printing position. Data indicating the print subject to be printed by the handy printer 100 is transmitted by a terminal device 200. Examples of the terminal device 200 include a smartphone or a tablet personal computer (PC), which is equipped with a display 240. The handy printer 100 and the terminal device 200 are configured to be communicatively connected to each other via a wireless link. A printing system 1 includes the handy printer 100 and the terminal device 200.

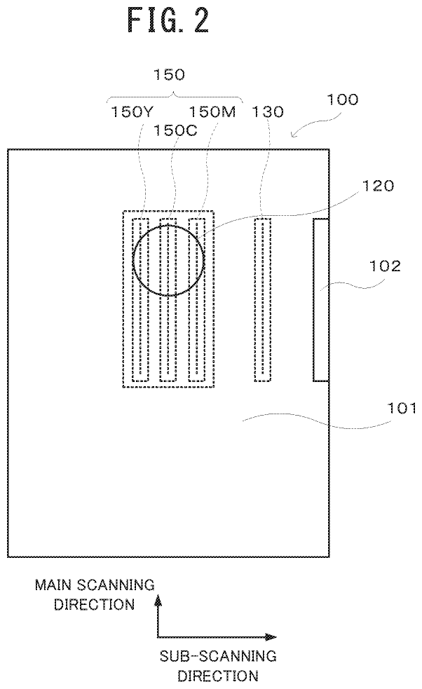

As illustrated in FIG. 2, the handy printer 100 includes a mark 102 and an indicator 120 on a top surface of the handy printer 100. The mark 102 indicates where the print head 150 passes when the handy printer 100 is moved in the sub-scanning direction (scan direction). The indicator 120, which indicates a status of printing, includes a light emitting diode (LED) for emitting red light, an LED for emitting green light, and an LED for emitting blue light and emits any color of light.

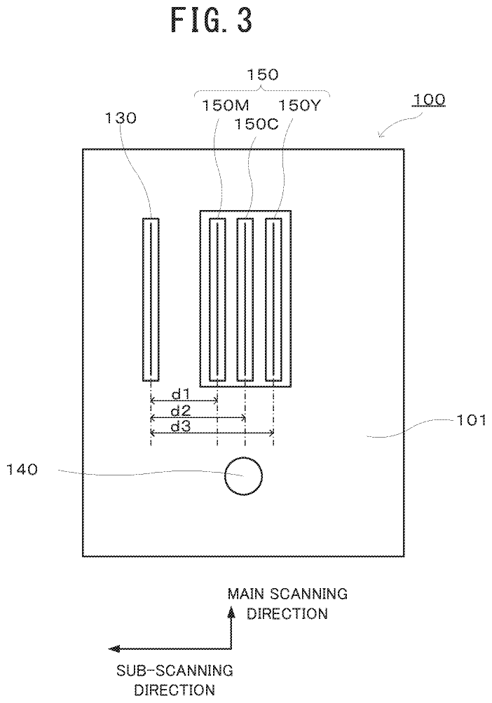

As illustrated in FIG. 3, the handy printer 100 includes an image acquirer 130, a travel distance detector 140, and a print head 150 on a bottom surface of the handy printer 100.

The image acquirer 130 includes a scanner including optical elements arranged linearly in a main scanning direction. The scanner scans the print medium R to acquire an image of the print medium R. The image acquirer 130 is disposed ahead of the print head 150 in the scan direction and acquires an image of the print medium R prior to printing by the print head 150. The main scanning direction is orthogonal to the sub-scanning direction.

The travel distance detector (sensor) 140 includes a light source such as an LED, and an optical sensor, and detects a distance by which the handy printer 100 is moved in the sub-scanning direction.

The print head 150 includes a magenta-color print head 150M that ejects magenta-color ink, a cyan-color print head 150C that ejects cyan-color ink, a yellow-color print head 150Y that ejects yellow-color ink, and non-illustrated ink tanks for the corresponding colors. Each of the print heads 150M, 150C, and 150Y has nozzles, which are print elements, arranged linearly in the main scanning direction (set direction). The print head 150 ejects ink selectively from the nozzles upon electrical energization corresponding to an image of the print subject. The magenta-color print head 150M is disposed apart by a reference distance d1 from the image acquirer 130 in the sub-scanning direction. The cyan-color print head 150C is disposed apart by a reference distance d2 from the image acquirer 130 in the sub-scanning direction. The yellow-color print head 150Y is disposed apart by a reference distance d3 from the image acquirer 130 in the sub-scanning direction.

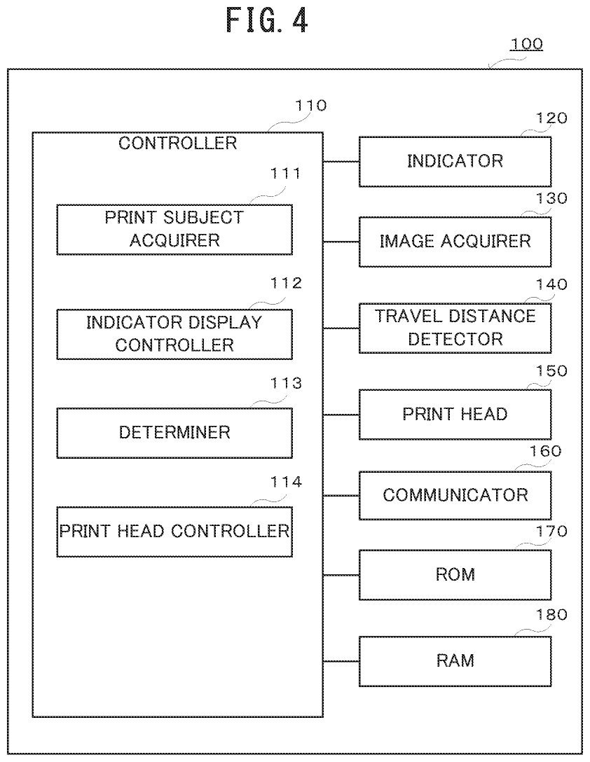

As electrical components, the handy printer 100 includes the indicator 120, the image acquirer 130, the travel distance detector 140, and the print head 150, as described above, and further includes a controller 110, a communicator 160, a read only memory (ROM) 170, and a random access memory (RAM) 180, as illustrated in FIG. 4.

The controller 110 includes a central processing unit (CPU). The controller 110 functions as a print subject acquirer 111, an indicator display controller 112, a determiner 113, and a print head controller 114 by executing programs stored in the ROM 170.

The print subject acquirer 111 acquires, via the communicator 160, data indicating the print subject transmitted by the terminal device 200, data indicating the reference pattern, and data indicating a relative position of the reference pattern with respect to an intended position at which the print subject is to be printed, and stores the acquired data in the RAM 180. The reference pattern is a characteristic pattern preprinted on the print medium R and serves as a reference of a printing position of the print subject. The relative position of the reference pattern with respect to the intended position at which the print subject is to be printed is, for example, represented by a sub-scanning-direction distance between the reference pattern and the print subject.

The indicator display controller 112 turns on lighting of the indicator 120 in accordance with the travel distance. Upon the print subject acquirer 111 acquiring data indicating the print subject, data indicating the reference pattern, and data indicating a relative position of the reference pattern with respect to the intended position at which the print subject is to be printed, the indicator display controller 112 changes a lighting color of the indicator 120 to green. Upon the later-described determiner 113 detecting the reference pattern, the indicator display controller 112 changes the lighting color of the indicator 120 to yellow. Upon start of printing, the indicator display controller 112 changes the lighting color of the indicator 120 to white. Upon completion of the printing, the indicator display controller 112 changes the lighting color of the indicator 120 to blue. Then after passage of a fixed period, lighting of the indicator 120 is turned off.

The determiner 113 determines whether the reference pattern that serves as a reference of the printing position of the print subject is included in an image acquired by the image acquirer 130 by scanning and whether a total distance of the reference distance d1 and a sub-scanning-direction distance between the reference pattern and the print subject has been traveled since detection of the reference pattern. Upon the handy printer 100 being moved by a user, the image acquirer 130 scans the print medium R and acquires the image of the print medium R. The determiner 113 extracts an amount of features from the image acquired by the image acquirer 130 and determines whether an amount by which the extracted features match features included in the reference pattern is equal to or greater than a reference value.

When the determiner 113 determines that the reference pattern is included, the print head controller 114 causes the print head 150 to print the print subject based on a travel distance that is a distance traveled in the sub-scanning direction and detected by the travel distance detector 140, using the position of the reference pattern as a reference of the printing position. Specifically, the print head controller 114 detects the travel distance L that has been traveled since detection of the reference pattern. Then the print head controller 114 causes ejection of ink from the magenta-color print head 150M to print a single line of dots for magenta color of the print subject corresponding to a position obtained by subtraction of a total distance the distance d4 and the reference distance d1 from the travel distance L, which can also be briefly expressed as L−(d4+d1). Then the print head controller 114 causes ejection of ink from the cyan-color print head 150C to print a single line of dots for cyan color of the print subject corresponding to a position obtained by subtraction of a total distance of the distance d4 and the reference distance d2 from the travel distance L, which can also be briefly expressed as L−(d4+d2). Then the print head controller 114 causes ejection of ink from the yellow-color print head 150Y to print a single line of dots for yellow color of the print subject corresponding to a position obtained by subtraction of a total distance of the distance d4 and the reference distance d3 from the travel distance L, which can also be briefly expressed as L−(d4+d3).

As described above, the travel distance detector 140 detects the travel distance L that is a distance by which the print head 150 is moved relative to the print medium R, and outputs to the controller 110 data indicating the detected travel distance L.

The print head 150 selectively ejects, in accordance with print data, ink onto the print medium R through nozzles included in the print head 150 under control of the print head controller 114, as described above. The ejected ink attaches to the print medium R and a single line of dots, which is a line of dots arranged in the main scanning direction of the print head 150, is printed.

The communicator 160 receives data indicating the print subject from the terminal device 200. Examples of the communicator 160 include wireless communication modules, such as wireless local area network (LAN) and Bluetooth (registered trademark) modules.

The ROM 170 is a non-volatile type of memory, such as a flash memory, and the ROM 170 stores data, such as the reference distances d1 to d3 and programs for implementing various functions by the controller 110, as described above. The RAM 180 is a volatile type of memory, and is used as working space for executing programs for processing by the controller 110. The RAM 180 stores information, such as image data for yellow (Y), magenta (M), and cyan (C) color of the print subject, a travel distance, a sub-scanning-direction distance d4 between the reference pattern and the print subject.

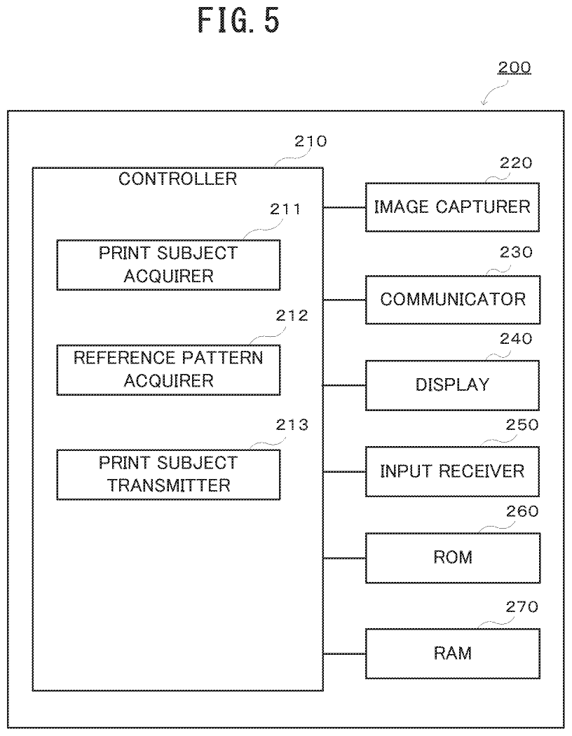

Next, the terminal device 200 illustrated in FIG. 1 is described. As illustrated in FIG. 5, the terminal device 200 includes a controller 210, an image capturer 220, a communicator 230, a display 240, an input receiver 250, a ROM 260, and a RAM 270.

The controller 210 includes the CPU. The controller 210 functions as a print subject acquirer 211, a reference pattern acquirer 212, and a print subject transmitter 213 by executing programs stored in the ROM 260.

The print subject acquirer 211 acquires data indicating the print subject received through the input receiver 250 or the communicator 230, and stores in the RAM 270 the acquired data indicating the print subject.

The reference pattern acquirer 212 acquires data indicating an image of the print medium R captured by the image capturer 220 and data indicating a distance between the image capturer 220 and the imaged print medium R, and displays on the display 240 the print subject as an overlay on the image of the print medium R. The distance between the image capturer 220 and the imaged print medium R can be determined from a focus adjustment stroke of a lens. In displaying the print subject, the reference pattern acquirer 212 adjusts the size of the print subject displayed on the display 240, based on the distance between the image capturer 220 and the imaged print medium R. The position and size of the print subject displayed on the display 240 can be adjusted through the input receiver 250 by a user operation. The reference pattern acquirer 212 specifies as the reference pattern a portion specified by a user operation, or extracts a characteristic portion from the image of the print medium R and specifies the extracted characteristic portion as the reference pattern. Specifically, the reference pattern acquirer 212 specifies as the reference pattern a characteristic pattern that is at a position through which the image acquirer 130 and the print head 150 pass before the print subject is printed (in FIG. 1, the position is located leftward from the printing position of the print subject). Alternatively, the reference pattern acquirer 212 may specify as the reference pattern a pattern having a feature selected by a user operation. Then the reference pattern acquirer 212 determines a relative position of the reference pattern with respect to an intended position at which the print subject is to be printed. Specifically, the reference pattern acquirer 212 determines the relative position based on the sub-scanning-direction distance d4 between the reference pattern and the print subject.

The print subject transmitter 213 transmits, via the communicator 230 to the handy printer 100, data indicating the print subject, data indicating the reference pattern, and data indicating the relative position of the reference pattern with respect to the intended position at which the print subject is to be printed.

The image capturer 220 includes a lens and an image sensor. The image capturer 220 captures an image of the print medium R and outputs to the controller 210 data indicating the captured image and data indicating the distance between the image capturer 220 and the imaged print medium R. The distance between the image capturer 220 and the imaged print medium R can be determined from a focus adjustment stroke of the lens that is a stroke for the image of the print medium R to be into focus.

The communicator 230 transmits to the handy printer 100 data indicating the print subject and the scan direction. Similarly to the aforementioned communicator 160, examples of the communicator 230 include wireless communication modules, such as wireless LAN and Bluetooth (registered trademark) modules.

The display 240 displays the image captured by the image capturer 220, the image of the input print subject, and an image necessary for operation. Examples of the display 240 include a liquid crystal display (LCD).

The input receiver 250 receives, in response to a user input, data indicating the print subject and instructions such as start and stop of printing processing. The input receiver 250 and the display 240 may together form a touch panel display device.

The ROM 260 is a non-volatile type of memory, such as a flash memory, and the ROM 260 stores programs for implementing various functions by the controller 210. The RAM 270 is a volatile type of memory, and is used as working space for executing programs for processing by the controller 210. The RAM 270 stores, for example, data indicating the image captured by the image capturer 220, data indicating the print subject and the reference pattern, and data indicating a relative position of the reference pattern with respect to the intended position at which the print subject is to be printed.

Next, an example process in which data indicating the print subject is transmitted to the handy printer 100 by the terminal device 200 configured as above and then the print subject is printed by the handy printer 100 is described, focusing on a printing process performed by the handy printer 100 and a print subject transmission process performed by the terminal device 200.

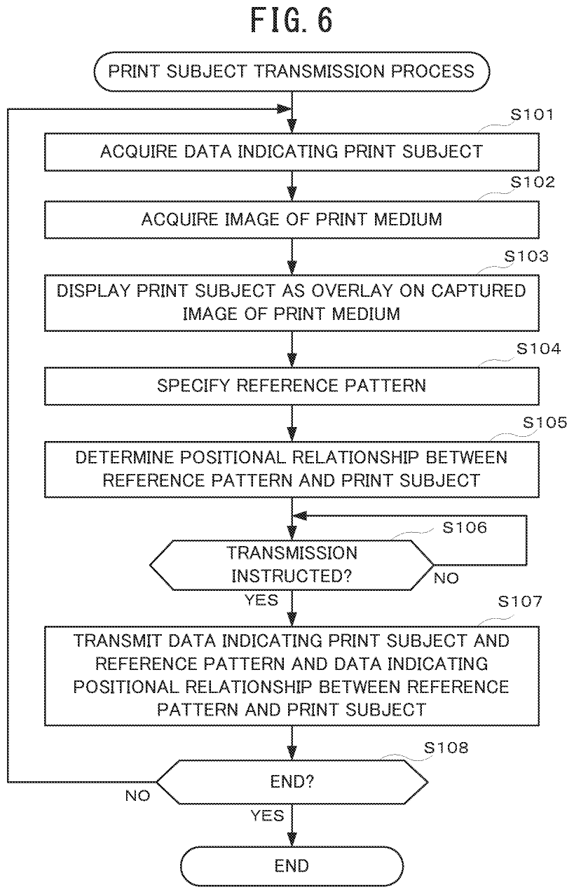

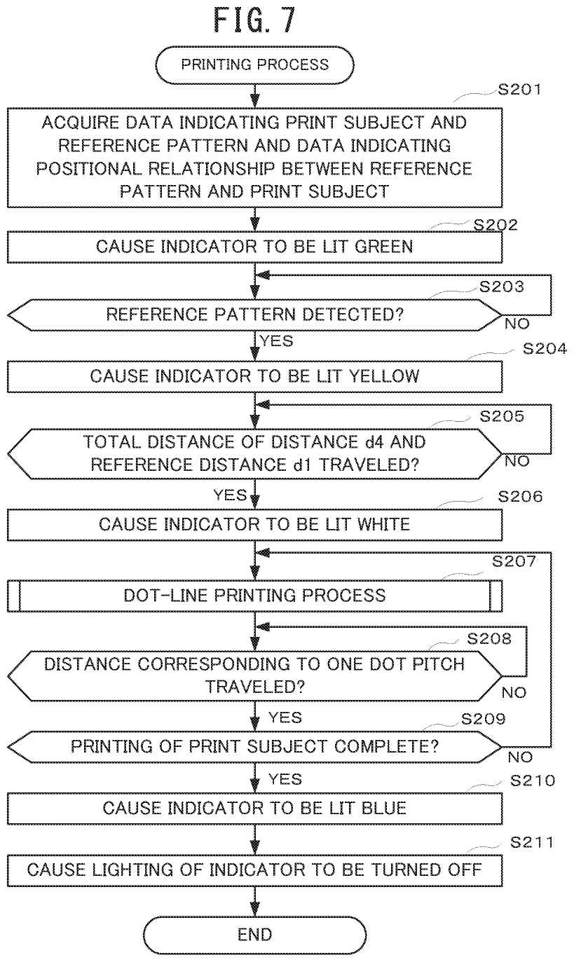

In response to a user instruction to start processing, the terminal device 200 starts a print subject transmission process illustrated in FIG. 6. In response to a user instruction to start processing, the handy printer 100 starts a printing process illustrated in FIG. 7. The print subject transmission process performed by the terminal device 200 and the printing process performed by the handy printer 100 are described below with reference to flow charts. In this example, a user prints the print subject using the reference pattern preprinted on the print medium R as a reference.

As illustrated in FIG. 6, the print subject acquirer 211 acquires data indicating the print subject input through the input receiver 250 (Step S101). The print subject acquirer 211 stores the acquired data indicating the print subject in the RAM 270. Then, upon the user operating the terminal device 200 to capture an image of the print medium R, the reference pattern acquirer 212 acquires the image of the print medium R captured by the image capturer 220 (Step S102). The reference pattern acquirer 212 then displays on the display 240 the print subject as an overlay on the image of the print medium R (Step S103). In displaying of the print subject, the size of the print subject displayed on the display 240 is adjusted based on a distance between the image capturer 220 and the imaged print medium R. The position and size of the print subject displayed on the display 240 may be adjusted through the input receiver 250 by a user operation.

Then the reference pattern acquirer 212 specifies a portion in the image of the print medium R as a reference pattern that serves as a reference for printing the print subject (Step S104). Specifically, the reference pattern acquirer 212 specifies as the reference pattern a characteristic pattern that is at a position through which the image acquirer 130 and the print head 150 pass before the print subject is printed (the position is located leftward from the printing position of the print subject). Then the reference pattern acquirer 212 determines a relative position of the reference pattern with respect to an intended position at which the print subject is to be printed (Step S105). Specifically, the reference pattern acquirer 212 determines the relative position based on the sub-scanning-direction distance d4 between the reference pattern and the print subject.

The print subject transmitter 213 determines whether an instruction to transmit the data indicating the print subject is received (Step S106). When a determination is made that the instruction to transmit the data is not received (No in Step S106), the process repeats Step S106. When a determination is made that the instruction to transmit the data is received (Yes in Step S106), the print subject transmitter 213 transmits, via the communicator 230 to the handy printer 100, data indicating the print subject, data indicating the reference pattern, and data indicating the relative position of the reference pattern with respect to the intended position at which the print subject is to be printed (Step S107). Then the print subject transmitter 213 determines whether an instruction to end the print subject transmission process is received (Step S108).

When a determination is made that the instruction to end the print subject transmission process is not received (No in Step S108), the process returns to Step S101 and repeats Steps S101 to S108. When a determination is made that the instruction to end the print subject transmission process is received (Yes in Step S108), the print subject transmission process ends.

In response to transmission by the terminal device 200 of data indicating the print subject, data indicating the reference pattern, and data indicating the relative position of the reference pattern with respect to the intended position at which the print subject is to be printed, the print subject acquirer 111 of the handy printer 100, as illustrated in FIG. 7, acquires the data indicating the print subject, the data indicating the reference pattern, and the data indicating the relative position of the reference pattern with respect to the position at which the print subject is to be printed, all of which are received via the communicator 160 from the terminal device 200, and stores the acquired data in the RAM 180 (Step S201). Then the indicator display controller 112 controls the indicator 120 to be lit green (Step S202). Through this lighting, the handy printer 100 notifies a user of the handy printer 100 being changed to a print standby state in which the handy printer 100 is ready for movement in the sub-scanning direction.

Upon movement of the handy printer 100 by the user, the determiner 113 determines whether the reference pattern is included in the image acquired by the image acquirer 130 (Step S203). Specifically, upon the handy printer 100 being moved, the image acquirer 130 scans the print medium R and acquires the image of the print medium R. The determiner 113 extracts an amount of features from the image acquired by the image acquirer 130 and determines whether an amount by which the extracted features match features included in the reference pattern is equal to or greater than a reference value. When a determination is made that the reference pattern is not included (No in Step S203), the process repeats Step S203. When a determination is made that the reference pattern is included (Yes in Step S203), the indicator display controller 112 controls the indicator 120 to be lit yellow (Step S204).

The determiner 113 detects the travel distance L and determines whether a total distance of the distance d4 and the reference distance d1 has been traveled since detection of the reference pattern (Step S205). When a determination is made that the total distance of the distance d4 and the reference distance d1 has not been traveled (No in Step S205), the process repeats Step S205. When a determination is made that the total distance of the distance d4 and the reference distance d1 has been traveled (Yes in Step S205), the indicator display controller 112 controls the indicator 120 to be lit white (Step S206). Then the print head controller 114 starts a dot-line printing process (Step S207).

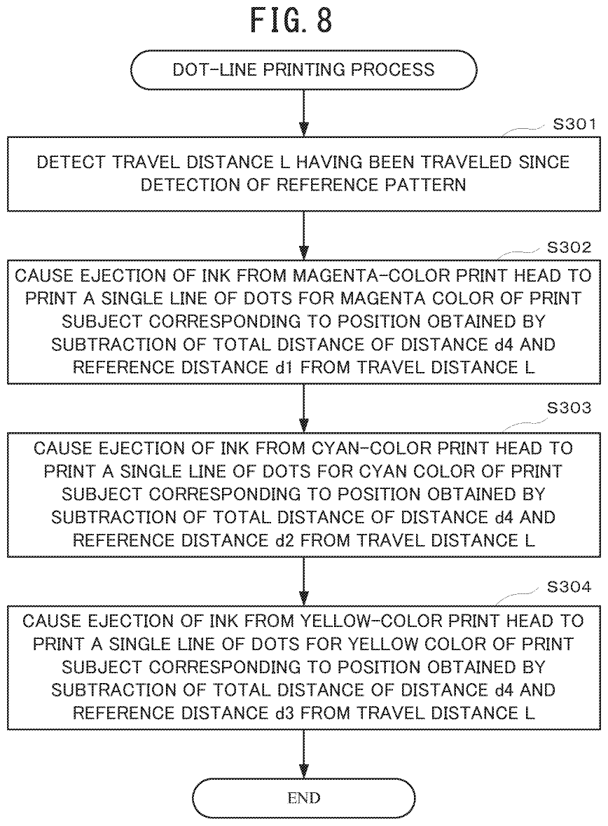

Upon start of the dot-line printing process, the print head controller 114, as illustrated in FIG. 8, detects the travel distance L that has been traveled since detection of the reference pattern (Step S301). Then the print head controller 114 causes ejection of ink from the magenta-color print head 150M onto the print medium R to print a single line of dots for magenta color of the print subject corresponding to a position obtained by subtraction of the total distance of the distance d4 and the reference distance d1 from the travel distance L, which can also be briefly expressed as L−(d4+d1) (Step S302). Then the print head controller 114 causes ejection of ink from the cyan-color print head 150C onto the print medium R to print a single line of dots for cyan color of the print subject corresponding to a position obtained by subtraction of the total distance of the distance d4 and the reference distance d2 from the travel distance L, which can also be briefly expressed as L−(d4+d2) (Step S303). When the travel distance L is less than the total distance of the distance d4 and the reference distance d2, the print head controller 114 does not cause ejection of ink from the cyan-color print head 150C. Then the print head controller 114 causes ejection of ink from the yellow-color print head 150Y onto the print medium R to print a single line of dots for yellow color of the print subject corresponding to a position obtained by subtraction of the total distance of the distance d4 and the reference distance d3 from the travel distance L, which can also be briefly expressed as L−(d4+d3) (Step S304). When the travel distance L is less than a total distance of the distance d4 and the reference distance d3, the print head controller 114 does not cause ejection of ink from the yellow-color print head 150Y. Then the dot-line printing process ends and the process returns to the printing process illustrated in FIG. 7.

The print head controller 114 determines whether a distance corresponding to one dot pitch has been traveled (Step S208). When a determination is made that the distance corresponding to one dot pitch has not been traveled (No in Step S208), the process repeats Step S208. When a determination is made that the distance corresponding to one dot pitch has been traveled (Yes in Step S208), the print head controller 114 determines whether printing of the print subject is complete (Step S209). When a determination is made that the printing of the print subject is not complete (No in Step S209), the process returns to Step S207, and repeats Steps S207 to S209 until the printing is complete.

When a determination is made that the printing of the print subject is complete (Yes in Step S209), the indicator display controller 112 controls the indicator 120 to be lit blue (Step S210). Then after passage of a fixed period, the indicator display controller 112 controls lighting of the indicator 120 to be tuned off (Step S211). Then the printing process ends.

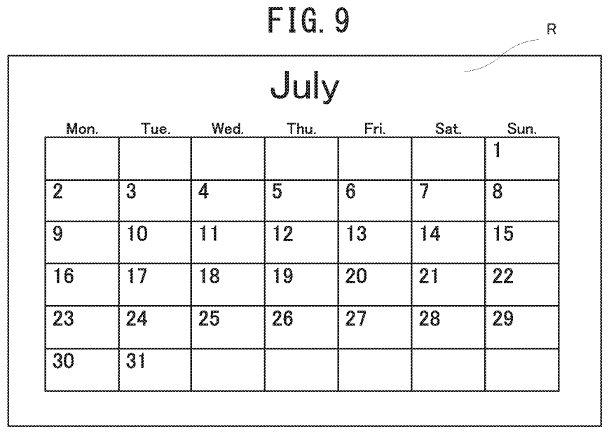

Next, processing performed by the handy printer 100 and the terminal device 200 according to the embodiment is described using a specific example with reference to FIGS. 9 to 14.

This example describes printing of a print subject, “Off”, in a segment of July 6th on a calendar preprinted on the print medium R illustrated in FIG. 9.

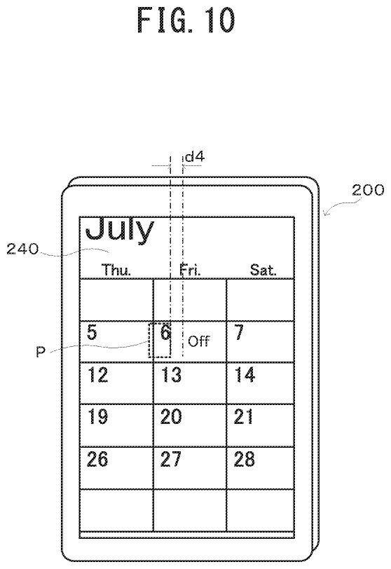

First, in response to a user instruction to start processing, the handy printer 100 starts a printing process and the terminal devices 200 starts a print subject transmission process. Upon start of the print subject transmission process by the terminal device 200, the print subject acquirer 211 acquires data indicating the print subject, “Off”, received through the input receiver 250 from a user (Step S101; FIG. 6). The print subject acquirer 211 stores in the RAM 270 data indicating the acquired print subject. Then, upon the user operating the terminal device 200 to capture an image of the print medium R, the reference pattern acquirer 212 acquires the image of the print medium R captured by the image capturer 220 (Step S102; FIG. 6). In this example, the reference pattern acquirer 212 acquires an image including a portion meaning Day 6 on the calendar preprinted on the print medium R, as illustrated in FIG. 10. The reference pattern acquirer 212 then displays on the display 240 the print subject, “Off”, as an overlay on the image of the print medium R (Step S103; FIG. 6). In displaying of the print subject, the size of the print subject displayed on the display 240 is adjusted based on a distance between the image capturer 220 and the imaged print medium R. The position and size of the print subject displayed on the display 240 may be adjusted through the input receiver 250 by a user operation.

The reference pattern acquirer 212 specifies as the reference pattern a characteristic pattern included in the image of the print medium R (Step S104; FIG. 6). Specifically, the reference pattern acquirer 212 specifies as the reference pattern a characteristic pattern that is at a position through which the image acquirer 130 and the print head 150 pass before the print subject is printed (the position is located leftward from the printing position of the print subject). In this example, a portion P (portion enclosed by a dashed line in FIG. 10) including a numeral “6” meaning Day 6 and a line on the left side of the numeral “6” is specified as the reference pattern. Such specifying of the portion P as the reference pattern can avoid erroneous printing of the print subject on an unintended portion. Then the reference pattern acquirer 212 determines a relative position of the reference pattern with respect to an intended position at which the print subject is to be printed (Step S105; FIG. 6). Specifically, the relative position is represented by the sub-scanning-direction distance d4 between the reference pattern and the print subject.

Upon reception of an instruction to transmit the data indicating the print subject (Yes in Step S106; FIG. 6), the print subject transmitter 213 transmits, via the communicator 230 to the handy printer 100, data indicating the print subject, data indicating the reference pattern, and data indicating the relative position of the reference pattern with respect to the intended position at which the print subject is to be printed (Step S107; FIG. 6).

In response to transmission by the terminal device 200 of data indicating the print subject, data indicating the reference pattern, and data indicating the relative position of the reference pattern with respect to the intended position at which the print subject is to be printed, the print subject acquirer 111 of the handy printer 100 acquires the data indicating the print subject, the data indicating the reference pattern, and the data indicating the relative position of the reference pattern with respect to the intended position at which the print subject is to be printed, all of which are received via the communicator 160 from the terminal device 200, and stores the acquired data in the RAM 180 (Step S201; FIG. 7). Then the indicator display controller 112 controls the indicator 120 to be lit green (Step S202; FIG. 7). Through this lighting, the handy printer 100 notifies a user of the handy printer 100 being changed to a print standby state in which the handy printer 100 is ready for movement in the sub-scanning direction.

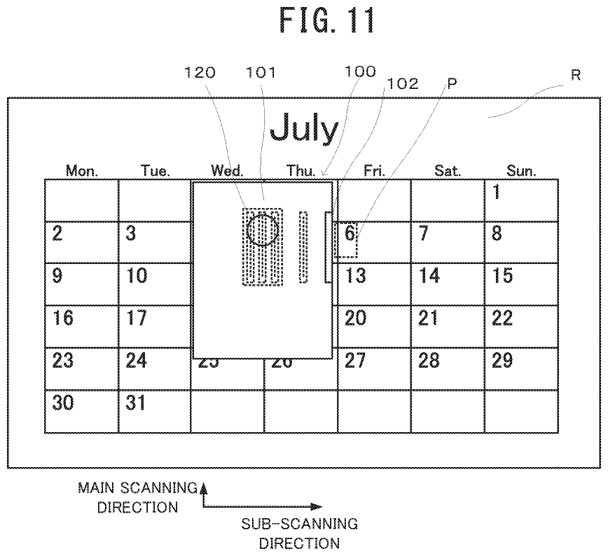

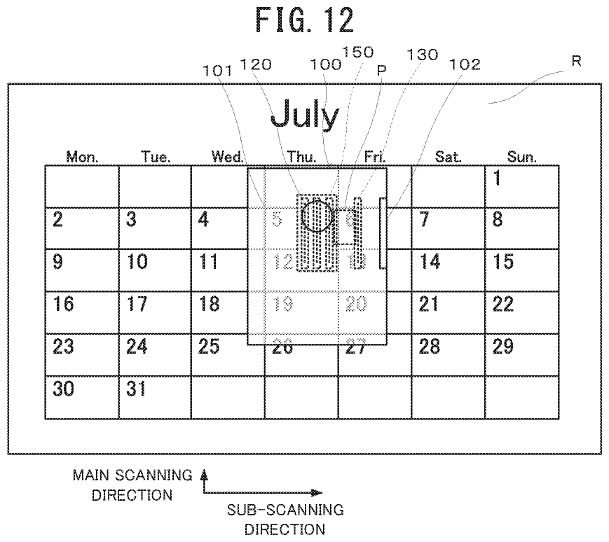

Then, as illustrated in FIG. 11, the user positions the handy printer 100 with the mark 102 in place where the handy printer 100, upon movement, passes through a Day 6 location (location including the reference pattern) on the calendar preprinted on the print medium R. Then the determiner 113 determines whether the portion P, which is the reference pattern, is included in the image acquired by the image acquirer 130 (Step S203; FIG. 7). As illustrated in FIG. 12, when the handy printer 100 is moved by the user and the image acquirer 130 passes through the portion P, the image acquirer 130 acquires the image of the portion P. Based on the acquisition, the determiner 113 determines that the reference pattern is included (Yes in Step S203; FIG. 7). Then the indicator display controller 112 controls the indicator 120 to be lit yellow (Step S204; FIG. 7).

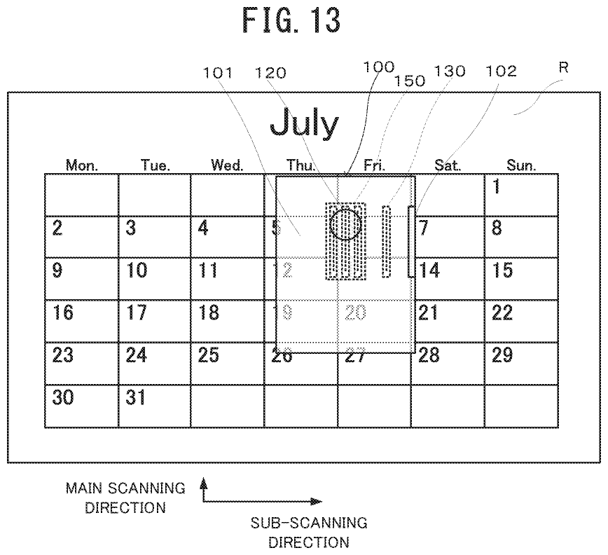

The determiner 113 detects the travel distance L and determines whether a total distance of the distance d4 and the reference distance d1 has been traveled since detection of the reference pattern (Step S205; FIG. 7). Upon movement of the handy printer 100 to the position illustrated in FIG. 13, the determiner 113 determines that the total distance of the distance d4 and the reference distance d1 has been traveled (Yes in Step S205; FIG. 7), and the indicator display controller 112 controls the indicator 120 to be lit white (Step S206; FIG. 7). Then the print head controller 114 starts the dot-line printing process (Step S207; FIG. 7).

Upon start of the dot-line printing process, the print head controller 114 detects the travel distance L that has been traveled since detection of the reference pattern (Step S301; FIG. 8). Then the print head controller 114 causes ejection of ink from the magenta-color print head 150M to print a single line of dots for magenta color of the print subject corresponding to a position obtained by subtraction of the total distance of the distance d4 and the reference distance d1 from the travel distance L, which can also be briefly expressed as L−(d4+d1) (Step S302; FIG. 8). Then the print head controller 114 causes ejection of ink from the cyan-color print head 150C to print a single line of dots for cyan color of the print subject corresponding to a position obtained by subtraction of the total distance of the distance d4 and the reference distance d2 from the travel distance L, which can also be briefly expressed as L−(d4+d2) (Step S303; FIG. 8). Then the print head controller 114 causes ejection of ink from the yellow-color print head 150Y to print a single line of dots for yellow color of the print subject corresponding to a position obtained by subtraction of the total distance of the distance d4 and the reference distance d3 from the travel distance L, which can also be briefly expressed as L−(d4+d3) (Step S304; FIG. 8). Then the dot-line printing process ends and the process returns to the printing process.

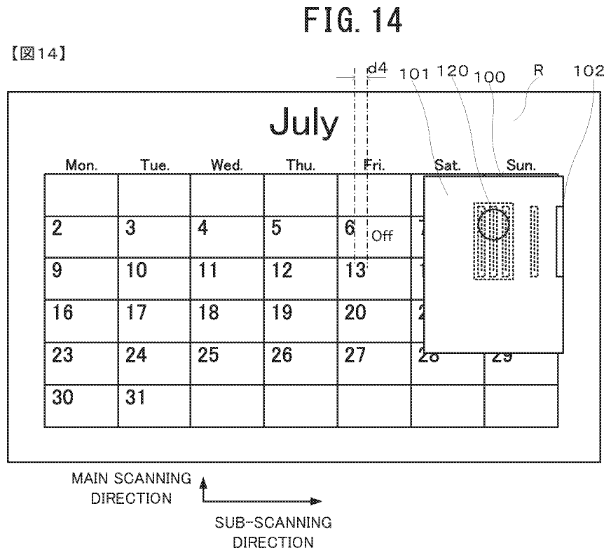

When the print head controller 114 determines that a distance corresponding to one dot pitch has been traveled (Yes in Step S208; FIG. 7) and then determines that the printing of the print subject is not complete (No in Step S209; FIG. 7), the print head controller 114 returns to Step S207 and the process repeats Steps S207 to S209 until the printing is complete. As illustrated in FIG. 14, when a determination is made that the printing of the print subject is complete (Yes in Step S209, FIG. 7), the indicator display controller 112 controls the indicator 120 to be lit blue (Step S210; FIG. 7). Then after passage of a fixe period, the indicator display controller 112 controls lighting of the indicator 120 to be turned off (Step S211; FIG. 7). Then the printing process ends.

As described above, according to the printing system 1 and the handy printer 100 according to the embodiment of the present disclosure, the print subject can be printed on the print medium R based on a relative position of a position at which the reference pattern is detected with respect to an intended position at which the print subject is to be printed. This can achieve printing of the print subject at an accurate position relative to the reference pattern. The terminal device 200 displays the print subject as an overlay on the image of the print medium R on the display 240 before printing. In displaying of the print subject, a user can adjust the position and size of the print subject displayed on the display 240 by operation of the input receiver 250. This enables the user to check the printing position beforehand and decide the position and size of the print subject not to be printed over the characters and the like preprinted on the print medium R.

### Modified Embodiments

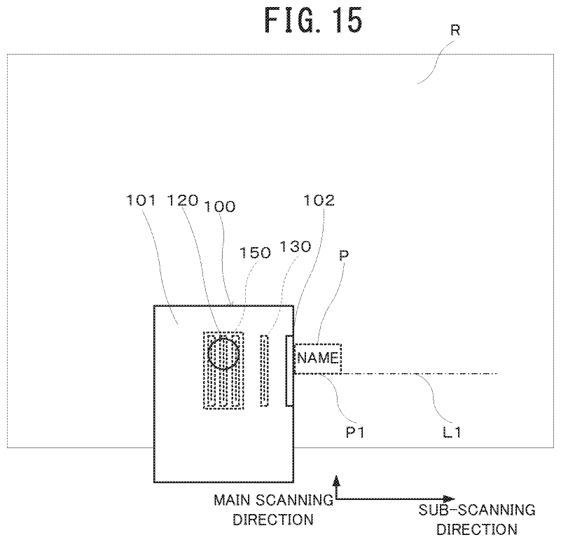

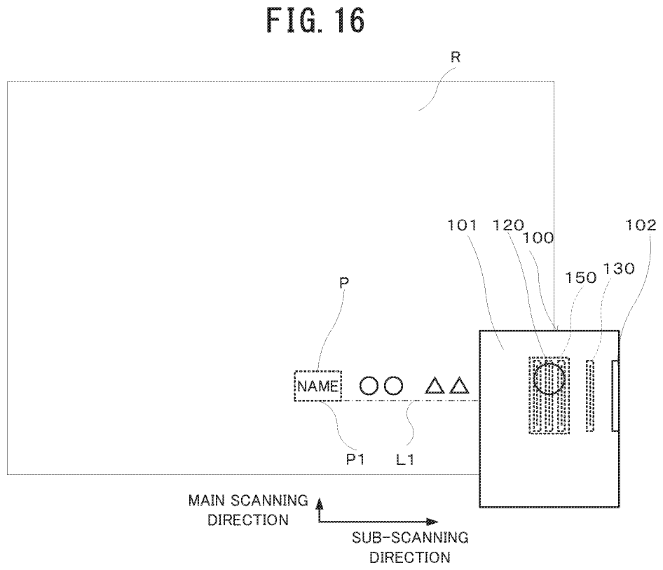

The handy printer 100 according to the aforementioned embodiment is described with an example in which the print subject is printed upon by the total distance of the distance d4 and the reference distance d1 having been traveled since detection of the reference pattern. The relative position of the reference pattern with respect to the intended position at which the print subject is to be printed may be adjusted in accordance with a position of the reference pattern in the main scanning direction. Specifically, the print head controller 114 causes the print head 150 to print the print subject at a main-scanning-direction relative position of a pre-stored reference pattern with respect to the intended position at which the print subject is to be printed, based on the main-scanning-direction position of the reference pattern acquired by the image acquirer 130. An example in which the portion P is the reference pattern such as illustrated in FIG. 15 is considered. In this case, printing of the print subject may be positioned such that the lower end of the print subject is aligned on a line L1 that extends in the sub-scanning direction from a lower end P1 of the reference pattern. When the handy printer 100 is moved by a user and the image acquirer 130 passes through the portion P, the image acquirer 130 acquires the image of the portion P. The determiner 113 detects the reference pattern and locates the lower end P1 of the portion P included in the image acquired by the image acquirer 130. The print head controller 114, as illustrated in FIG. 16, generates an image on which the lower end of the print subject is located on the line L1 extending in the sub-scanning direction from the lower end P1, and prints the generated image on the print medium R. This can achieve adjustment of the printing position for the print subject by shifting the position in the main scanning direction in accordance with deviation of the travel position, which can keep the relative position of the reference pattern with respect to the print subject even when the handy printer 100 is moved off-course in the main scanning direction. Although the print subject is printed, in this example, such that the lower end of the print subject is aligned with the lower end P1 of the reference pattern, the print subject may be printed such that an upper end of the print subject is aligned with an upper end of the reference pattern.

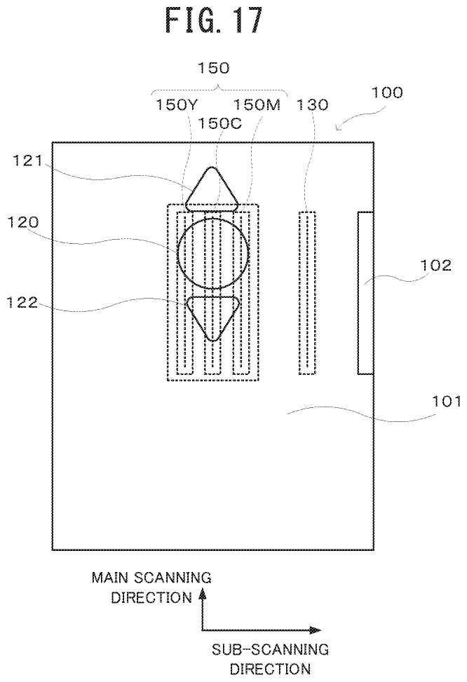

The handy printer 100 according to the aforementioned embodiment is described with an example in which the print subject is printed after detection of the reference pattern. When a user moves the handy printer 100, off-course movement of the handy printer 100 from the reference pattern may occur. In such a case, correction of the travel position is difficult unless the user knows a direction of deviation. The handy printer 100 may include a notifier that notifies a user of deviation of the travel position from the position of the reference pattern when the deviation is detected in the image acquired by the image acquirer 130. Specifically, when the controller 110 detects a portion of the reference pattern and detects deviation of the travel position, the notifier notifies a user of the travel position being deviated. For example, as illustrated in FIG. 17, the handy printer 100 may include an upper indicator 121 and a lower indicator 122 in addition to the indicator 120. The upper indicator 121 notifies a user of necessity to perform a rescan with the handy printer 100 shifted upward, and the lower indicator 122 notifies a user of necessity to perform a rescan with the handy printer shifted downward. The upper indicator 121 and the lower indicator 122 function as a notifier. In this case, when the determiner 113 determines that an upper portion of the reference pattern is included in the image acquired by the image acquirer 130, the indicator display controller 112 turns on lighting of the lower indicator 122. When the determiner 113 determines that a lower portion of the reference pattern is included in the image acquired by the image acquirer 130, the indicator display controller 112 turns on lighting of the upper indicator 121. Following the indication, the user performs the rescan with the handy printer 100 shifted upward or downward to print the print subject. Instead of the upper indicator 121 and the lower indicator 122, the notifier may be a speaker that provides audio notification of deviation.

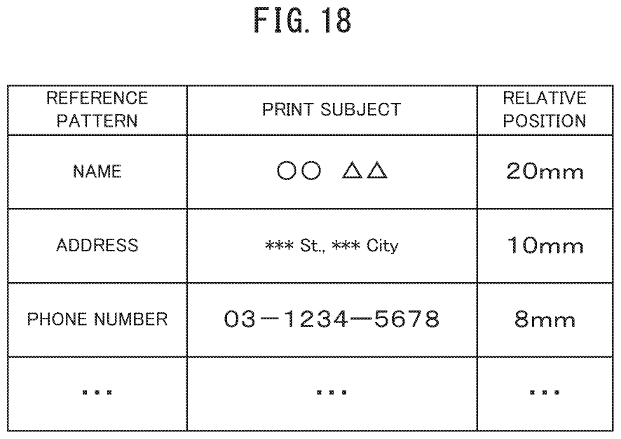

The handy printer 100 according to the aforementioned embodiment is described with an example in which the handy printer 100 receives, from the terminal device 200, data indicating the print subject, data indicating the reference pattern, and data indicating the relative position of the reference pattern with respect to the intended position at which the print subject is to be printed. The handy printer 100 may prestore, in the ROM 170, data indicating the print subject, data indicating the reference pattern, and data indicating the relative position of the reference pattern with respect to the intended position at which the print subject is to be printed. For example, as illustrated in FIG. 18, data indicating the reference pattern, data indicating the print subject, and data indicating the relative position are stored in association with one another. When the reference pattern acquirer 212 of the handy printer 100 detects “telephone number” as the reference pattern from the image scanned by the image acquirer 130, the print head controller 114 causes the print head 150 to print the print subject, “03-1234-5678”, at a position where the sub-scanning-direction distance between the reference pattern and the print subject is 8 mm. In this case, the print subject may be printed by adjusting the size of the print subject such that the size (font size) of the reference pattern is the same as the size (font size) of the print subject. The relative position may be changed in accordance with the size of the reference pattern. For example, the relative position may be set such that the sub-scanning-direction distance between the reference pattern and the print subject is a length of one character of the reference pattern. The terminal device 200 may prestore, in the ROM 260, data indicating the print subject, data indicating the reference pattern, and data indicating the relative position of the reference pattern with respect to the intended position at which the print subject is to be printed.

The handy printer 100 according to the aforementioned embodiment is described with an example in which the image acquirer 130 includes the scanner having optical elements arranged linearly in the main scanning direction. The image acquirer 130 may be any image acquirer that can acquire an image of the print medium R prior to printing by the print head 150. The image acquirer 130, for example, may be a camera that captures an image of the print medium R.

The aforementioned embodiment is described with an example in which the terminal device 200 transmits data indicating the print subject, data indicating the reference pattern, and data indicating the relative position of the reference pattern with respect to the intended position at which the print subject is to be printed. The terminal device 200 may transmit any one of data indicating the print subject, data indicating the reference pattern, and data indicating the relative position of the reference pattern with respect to the intended position at which the print subject is to be printed.

The terminal device 200 according to the aforementioned embodiment is described with an example in which the reference pattern acquirer 212 acquires data indicating the image of the print medium R captured by the image capturer 220. The reference pattern acquirer 212 may acquire data indicating an image of the print medium R scanned by the image acquirer 130 of the handy printer 100. In this case, the handy printer 100 transmits, via the communicator 160, data indicating the image of the print medium R scanned by the image acquirer 130. The terminal device 200 receives, via the communicator 230, data indicating the image of the print medium R, and displays the image of the print medium R on the display 240. This enables accurate acquisition of the size of the reference pattern preprinted on the print medium R.

Although in the aforementioned embodiment, an example of ink ejection in which the print head 150 ejects magenta-color ink, cyan-color ink, and yellow-color ink from the corresponding nozzles is described, the print head 150 may be a print head that ejects one or two colors of ink or four or more colors of ink. In addition, the print head 150 is of an ink jet type with linearly arranged nozzles, but the print head 150 may be of a thermal type or another type.

The aforementioned embodiment is described with an example in which the travel distance detector 140 includes the light source such as an LED and the optical sensor. The travel distance detector 140 may be any detector that can detect a distance by which the handy printer 100 is traveled in the sub-scanning direction. The travel distance detector 140, for example, may include a roller that rotates upon movement and a sensor that counts the number of revolutions of the roller.

Although in the aforementioned embodiment, an example in which the handy printer 100 is separate from the terminal device 200 is described, the handy printer 100 may include components included in the terminal device 200.

A main part of the print subject transmission process and the printing process performed by the handy printer 100 and the terminal device 200, both of which include the CPU, the RAM, and the ROM, may be realized not by a dedicated system, but can be executed using a general personal digital assistant (a smartphone, a tablet PC, etc.), a personal computer, or the like, without use of a dedicated system. For example, an information terminal that executes the aforementioned processes may be realized by storing a computer program for executing the aforementioned operations in a computer-readable recording medium, such as a flexible disc, a compact disc read only memory (CD-ROM), a digital versatile disc read only memory (DVD-ROM), for distribution and installing the computer program into the personal digital assistant or the like. An information processing device may be configured, for example, by the general personal digital assistant or the like downloading the computer program stored in a storage included in a server device on a communication network, such as the Internet.

For example, in a case in which the functions of the handy printer 100 and the terminal device 200 are shared by an operating system (OS) and an application program or performed in cooperation between the OS and the application program, just the application program of those may be stored in a recording medium or a storage device.

The computer program may be superimposed on a carrier wave, and then may be distributed via a communication network. For example, this computer program may be posted to a bulletin board system (BBS) on a communication network, and may be distributed via the network. Then the computer program may be started and executed under control of an OS in the same manner as other application programs to execute the aforementioned processes.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A printing device comprising:
a housing;
a print head including print elements arranged linearly in a set direction in the housing;
a scanner disposed ahead of the print head in a scan direction that intersects the set direction and is a direction in which the housing is moved, the scanner being configured to acquire an image of a print medium; and
a processor configured to control, when determining that the image acquired by the scanner includes a reference pattern that serves as a reference of an intended position at which a print subject is to be printed, the print head to print the print subject at the intended position that is a set distance away from a position of the reference pattern in the scan direction and is adjusted in the set direction based on the position of the reference pattern.

2. The printing device according to claim 1, further comprising:
a sensor configured to detect a travel distance by which the housing is moved in the scan direction,
wherein when determining that the travel distance detected by the sensor and traveled since determination that the reference pattern is included is equal to or greater than a scan-direction distance between the reference pattern and the intended position at which the print subject is to be printed, the processor controls the print head to print the print subject at a position based on the intended position.

3. The printing device according to claim 2, wherein
the scanner includes optical elements arranged linearly in the set direction, and
when determining that the travel distance detected by the sensor and traveled since determination that the reference pattern is included is equal to or greater than a total distance of (i) the scan-direction distance between the reference pattern and the intended position at which the print subject is to be printed and (ii) a scan-direction distance between the print head and the scanner, the processor controls the print head to print the print subject at a position based on the intended position.

4. The printing device according to claim 1, wherein the processor is further configured to detect deviation of the travel position from the position of the reference pattern acquired by the scanner, and when detecting the deviation of the travel position, notify a user of the deviation of the travel position being detected.

5. The printing device according to claim 1, wherein the reference pattern is a character or a symbol.

6. A printing system comprising:
the printing device according to claim 1; and
a terminal device including a communicator to transmit, to the printing device, at least one of data indicating the reference pattern or data indicating the print subject.

7. The printing system according to claim 6, wherein the terminal device comprises
an image capturer configured to capture a print medium,
a display configured to display the print subject as an overlay on the print medium imaged by the image capturer, and
an input receiver configured to receive an input for an operation to adjust a position of the print subject displayed on the display.

8. The printing system according to claim 6, wherein
the printing device comprises a communicator to transmit, to the terminal device, data of an image of the print medium that is acquired beforehand by the scanner, and
the terminal device further comprises
a display configured to display the print subject as an overlay on the image of the print medium transmitted by the printing device, and
an input receiver configured to receive an input for an operation to adjust a position of the print subject displayed on the display.

9. The printing system according to claim 7, wherein the terminal device further comprises a reference pattern acquirer configured to specify as the reference pattern a characteristic portion included in the image of the print medium, and acquire a relative position of the reference pattern with respect to an intended position at which the print subject is to be printed.

10. A printing method for a printing device including
a housing,
a print head including print elements arranged linearly in a set direction in the housing, and
a scanner disposed ahead of the print head in a scan direction that intersects the set direction and is a direction in which the housing is moved, the scanner being configured to acquire an image of a print medium, the printing method comprising:
controlling, when determining that the image acquired by the scanner includes a reference pattern that serves as a reference of an intended position at which a print subject is to be printed, the print head to print the print subject at the intended position that is a set distance away from a position of the reference pattern in the scan direction and is adjusted in the set direction based on the position of the reference pattern.

11. The printing method according to claim 10, wherein
the printing device further comprises a sensor configured to detect a travel distance by which the housing is moved in the scan direction, and
the controlling of the print head includes controlling the print head to print the print subject at a position based on the intended position when determining that the travel distance detected by the sensor and traveled since determination that the reference pattern is included is equal to or greater than a scan-direction distance between the reference pattern and the intended position at which the print subject is to be printed.

12. The printing method according to claim 11, wherein
the scanner includes optical elements arranged linearly in the set direction, and
the controlling of the print head includes controlling the print head to print the print subject at a position based on the intended position when determining that the travel distance detected by the sensor and traveled since determination that the reference pattern is included is equal to or greater than a total distance of (i) the scan-direction distance between the reference pattern and the intended position at which the print subject is to be printed and (ii) a scan-direction distance between the print head and the scanner.

13. The printing method according to claim 10, wherein the controlling of the print head includes detecting deviation of the travel position from the position of the reference pattern acquired by the scanner, and when detecting the deviation of the travel position, notifying a user of the deviation of the travel position being detected.

14. The printing method according to claim 10, wherein the reference pattern is a character or a symbol.

15. A non-transitory computer-readable recording medium storing a program for execution on a computer for controlling a printing device that includes a housing, a print head including print elements arranged linearly in a set direction in the housing, and a scanner disposed ahead of the print head in a scan direction that intersects the set direction and is a direction in which the housing is moved, the scanner being configured to acquire an image of a print medium, the program causing the computer to execute:
controlling, when determining that the image acquired by the scanner includes a reference pattern that serves as a reference of an intended position at which a print subject is to be printed, the print head to print the print subject at the intended position that is a set distance away from a position of the reference pattern in the scan direction and is adjusted in the set direction based on the position of the reference pattern.

16. The non-transitory computer-readable recording medium according to claim 15, wherein
the printing device further includes a sensor configured to detect a travel distance by which the housing is moved in the scan direction, and
the controlling of the print head includes controlling the print head to print the print subject at a position based on the intended position when determining that the travel distance detected by the sensor and traveled since determination that the reference pattern is included is equal to or greater than a scan-direction distance between the reference pattern and the intended position at which the print subject is to be printed.

17. The non-transitory computer-readable recording medium according to claim 16, wherein
the scanner includes optical elements arranged linearly in the set direction, and
the controlling of the print head includes controlling the print head to print the print subject at a position based on the intended position when determining that the travel distance detected by the sensor and traveled since determination that the reference pattern is included is equal to or greater than a total distance of (i) the scan-direction distance between the reference pattern and the intended position at which the print subject is to be printed and (ii) a scan-direction distance between the print head and the scanner.

18. The non-transitory computer-readable recording medium according to claim 15, wherein the controlling of the print head further includes detecting deviation of the travel position from the position of the reference pattern acquired by the scanner, and when detecting the deviation of the travel position, notifying a user of the deviation of the travel position being detected.

19. The non-transitory computer-readable recording medium according to claim 15, wherein the reference pattern is a character or a symbol.
